(19) United States
(12) Patent Application Publication
(10) Pub. No.: US 2006/0060044 A1
(43) Pub. Date: Mar. 23, 2006

(54) Corrugating plant and method for the manufacture of sheets of corrugated board

(75) Inventors: Felix Titz, Weiherhammer (DE); Karl Ruhland, Pfreimd (DE)

Correspondence Address: BROWDY AND NEIMARK, P.L.L.C.;624 NINTH STREET, NW, SUITE 300, WASHINGTON, DC, 20001-5303, US

(73) Assignee: BHS Corrugated Maschinen - und Anlagenau GmbH, Weiherhammer (DE)

(21) Appl. No.: 11/231,971

(22) Filed: Sep. 22, 2005

(30) Foreign Application Priority Data
Sep. 23, 2004 (DE) 10 2004 046127.9

(51) Int. Cl. B26D 1/00

(52) U.S. Cl. 83/13; 493/340

(57) ABSTRACT

In a corrugating plant for the manufacture of sheets of corrugated board, it is provided, for improved flexibility and productivity to be obtained, that several continuous sectional webs of corrugated board Bᵢ, which are allocated to varying formats of sheets of corrugated board, are produced from a web of corrugated board on a cutter and grooving unit; that they are divided on a switch into at least three levels and supplied to a cross cutter with at least three sectional cross cutters for sheets of corrugated board to be cut to size. The fact that the web of corrugated board can be cut and divided into at least three sectional webs of corrugated board Bᵢ, raises the productivity and flexibility of the corrugating plant. Furthermore, a method of manufacturing sheets of corrugated is described.

### FIELD OF THE INVENTION

The invention relates to a corrugating plant for the manufacture of sheets of corrugated board. The invention further relates to a method of manufacturing sheets of corrugated board on a corrugating plant.

### BACKGROUND OF THE INVENTION

Corrugating plants serve for cutting to size sheets of corrugated board of a given format from the manufactured webs of corrugated board. For improved exploitation of the entire width of a web of corrugated board, the web is cut into two continuous, sectional webs which are allocated to two different formats; they are then cut and, via a switch, delivered to two different levels and afterwards cut crosswise. Upon change of format i.e., upon modification of the width of the sectional webs of corrugated board, the webs are not completely severed crosswise upstream of the switch so that both sectional webs of corrugated board are still continuous. For these two continuous sectional webs of corrugated board, after the change of format, to be delivered to two different levels, a crosscut must be made centrically crosswise of the conveying direction of the web of corrugated board, having a given length and a given position. This is known for example from EP 0 894 583 B 1.

Corrugating plants of the generic type for dividing a web of corrugated board into two sectional webs of corrugated board possess only restricted flexibility and productivity in the manufacture of sheets of corrugated board of varying format.

### SUMMARY OF THE INVENTION

It is an object of the invention further to develop a corrugating plant of the type mentioned at the outset for it to possess improved productivity and flexibility in the manufacture of sheets of corrugated board.

According to the invention, this object is attained by the features of claim 1. The gist of the invention resides in designing the corrugating plant in such a way that a continuous web of corrugated board can be cut and divided into at least three sectional webs of corrugated board which are allocated to varying formats of sheets of corrugated board. Several continuous sectional webs of corrugated board of predetermined and variably adjustable width can be produced by associated separating cuts by means of the cutter and divided into at least three levels by the switch. By means of the cross cutter, which comprises at least three sectional cross cutters, each continuous sectional web of corrugated board can be cut into sheets of corrugated board of the desired format.

Further advantageous embodiments of the invention will become apparent from the sub-claims.

Additional features, details and advantages of the invention will become apparent from the ensuing description of two exemplary embodiments, taken in conjunction with the drawing.

### BRIEF DESCRIPTION OF THE DRAWING

FIG. 1 is a diagrammatic side view of a corrugating plant according to a first exemplary embodiment;

FIG. 2 is a diagrammatic side view of a cross cutter unit according to FIG. 1;

FIG. 3 is a sectional view, on the line III-III, of the cross cutter unit according to FIG. 2;

FIG. 4 is an illustration of a first change of format on the corrugating plant according to FIG. 1;

FIG. 5 is an illustration of a second change of format on the corrugating plant according to FIG. 1;

FIG. 6 is an illustration of a third change of format on the corrugating plant according to FIG. 1;

FIG. 7 is a diagrammatic view of a corrugating plant according to a second exemplary embodiment; and

FIG. 8 is an illustration of a change of format on the corrugating plant according to FIG. 7.

### DESCRIPTION OF THE PREFERRED EMBODIMENTS

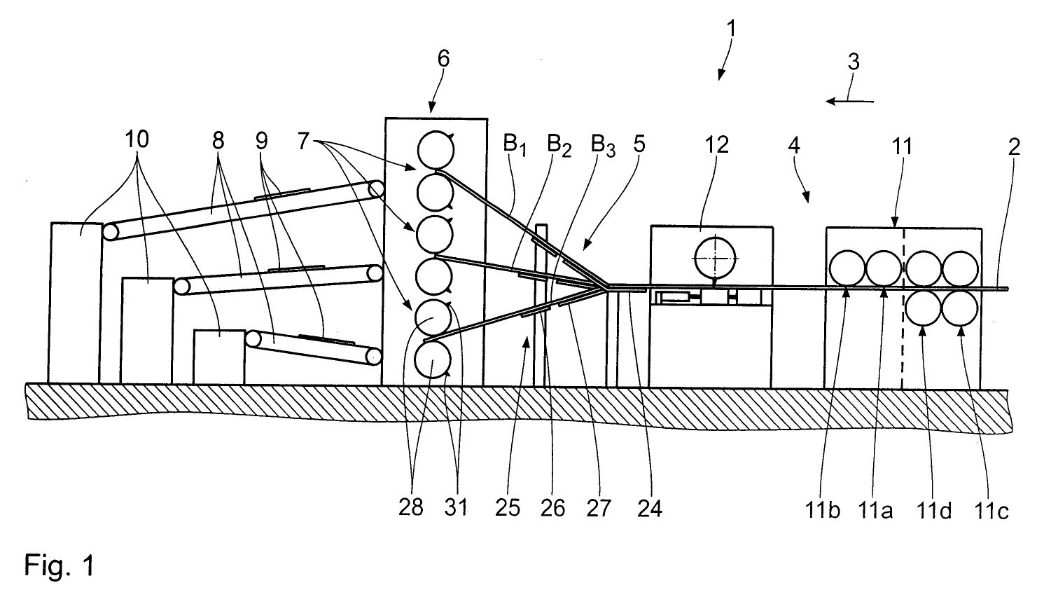

The following is a description of a first embodiment of the invention, taken in conjunction with FIGS. 1 to 6. A corrugating plant 1 comprises a customary corrugating machine for the production of webs of corrugated board, known for example from U.S. Pat. No. 5,632,850, GB 2 305 675 A or DE 43 05 158 A1, which reference is made to for further details. The corrugating machine is located to the right of FIG. 1 and not shown.

In a conveying direction 3 of the web of corrugated board 2, the corrugating plant 1 further successively comprises a cutter-and-grooving unit 4 for lengthwise and crosswise cutting as well as for grooving the still undivided web of corrugated board 2 into several continuous sectional webs of corrugated board Bᵢ, a switch 5 for dividing the sectional webs of corrugated board Bᵢ into three levels and a cross cutter 6 with three sectional cross cutters 7 for cutting to size sheets of corrugated board 9 from each continuous sectional web of corrugated board Bᵢ. Directly downstream of the cross cutter 6, provision is made for one conveyor belt 8 per sectional cross cutter 7, the belt 7 delivering the cut sheets of corrugated board 9 to a respective depository stack 10.

The cutter-and-grooving unit 4 comprises a longitudinal-cutter-and-grooving unit 11 and a cross-cutter unit 12 downstream as seen in the conveying direction 3. The longitudinal-cutter-and-grooving unit 11 comprises a first longitudinal-cutter unit 11a and a downstream, second longitudinal-cutter unit 11b. A first grooving unit 11c and a second grooving unit 11d are disposed upstream of the longitudinal-cutter units 11a, 11b The longitudinal-cutter units 11a and 11b comprise pivoted tool beds which are provided with rotating knives which are mounted on tool holders and which are individually displaceable crosswise of the conveying direction 3. The knives are individually movable for engagement with the web of corrugated board 2, cooperating with opposite, rotarily driven brush rolls (not shown) when the knives pass into the web of corrugated board 2. The grooving units 11c and 11d each comprise two pivoted tool beds which are substantially disposed one on top of the other in mirror symmetry to the web of corrugated board 2. The pivoted tool beds are provided with grooving tools which are mounted on tool holders for individual displacement crosswise of the conveying direction 3. The grooving tools are movable for individual engagement with the web of corrugated board 2. As regards the detailed design of the longitudinal-cutter-and-grooving unit 11, reference is made to U.S. Pat. No. 6,071,222 and DE 101 31 833 A.

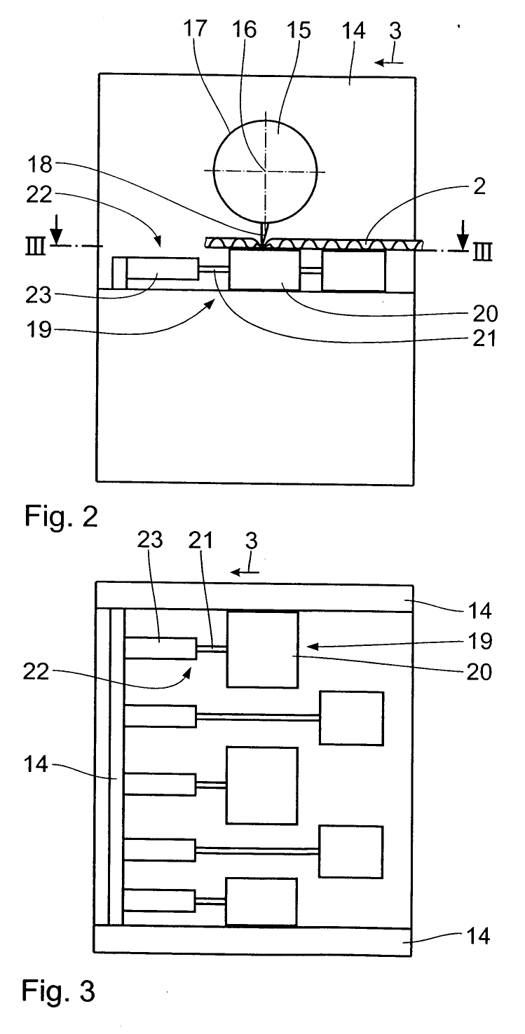

FIGS. 2 and 3 show the cross-cutter unit 12 of FIG. 1 in detail. The cross-cutter unit 12 comprises a casing 14 where a roll 15 is lodged, driven in rotation about an axis of rotation 16 that is perpendicular to the conveying direction 3. The casing 14 of the cross-cutter unit 12 is designed for the web of corrugated board 2 to be transportable through the cross-cutter unit 12 underneath the roll 15 that is driven in rotation. A knife 18 is fixed to the surface area 17 of the roll 15, projecting radially outwards and extending vertically of the conveying direction 3 across the entire width of the web of corrugated board 2. Several supports 19 are disposed side by side underneath the web of corrugated board 2 and perpendicular to the conveying direction 3. Each support 19 comprises a cutting support 20 which is also termed anvil and which is fixed to a piston rod 21 of a hydraulic cylinder 22. The piston rod 21 is displaceable in the conveying direction 3 in a casing 23 of the hydraulic cylinder 22. By its end that faces away from the piston-rod 21, the casing 23 is fixed to the casing 14.

Each cutting support 20 can be moved into a first and second position by means of the associated hydraulic cylinder 22. In the first position—the position of cutting—the cutting support 20 is directly underneath the roll 15. The vertical distance of the roll 15 from the cutting support 20 is selected such that the knife 18, upon rotation of the roll 15, does precisely not touch the cutting support 20. In the second position—the non-cutting position—the piston rod 21 of the hydraulic cylinder 22 is completely extended so that the cutting support 20 is located upstream of the roll 15 in the conveying direction 3.

The switch 5 comprises a feed table 24 for feed of the web of corrugated board 22 and a delivery-table unit 25 with three delivery tables 26 for three-level discharge of the web of corrugated board 2. For improved transfer of the web of corrugated board 2 from the feed table 24 on to the delivery tables 26, provision is made for several switch elements 27 which are disposed side by side on the feed table 24 for pivoting crosswise of the conveying direction and which are individually pivotable in relation to the delivery tables 26 into corresponding angular positions. For a detailed description of the fundamental design of the switch 5, please refer to DE 103 54 671.5.

The cross cutter 6 comprises three sectional cross cutters 7 which are disposed one on top of the other. Each sectional cross cutter 7 comprises two cross-cutter rolls 28 which are rotarily drivable and disposed one on top of the other and which extend crosswise of the conveying direction 3, with one cross-cutter roll 28 carrying a cross-cutter knife 31, which extends radially outwards, for completely severing the web of corrugated board 2 crosswise, consequently serving for cutting to size the sheets of corrugated board 9.

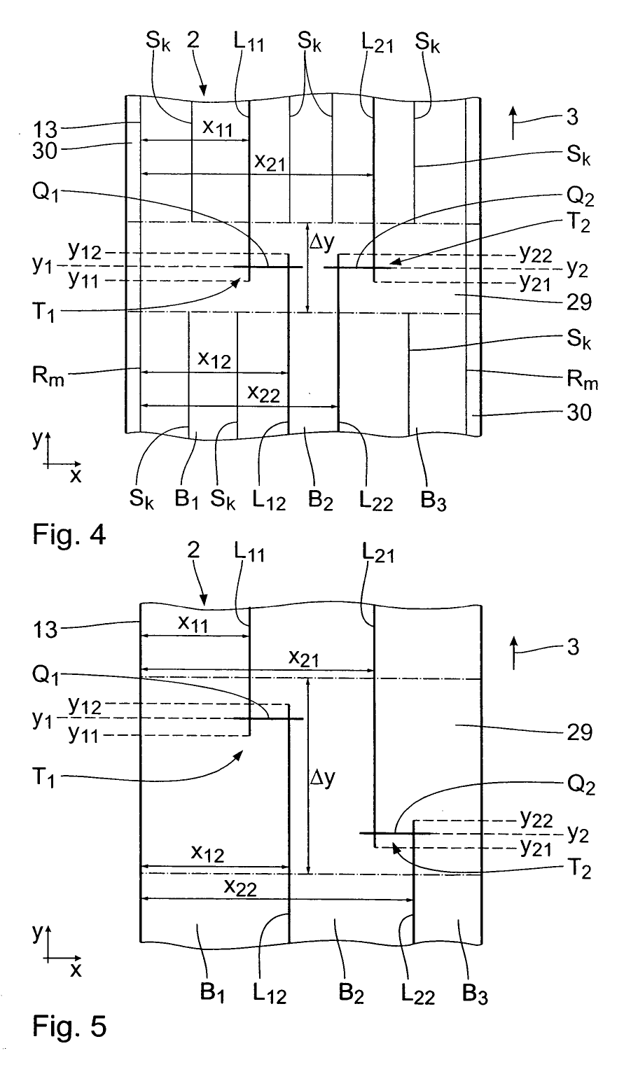

FIG. 4 illustrates the web of corrugated board 2 during a first change of format on the corrugating plant 1. FIG. 4 does not only explain a first example of a change of format, but it also explains the standard cutting of sectional webs during regular operation. The geometric array of the individual cuts of the web of corrugated board 2 is explained first. This is followed by an explanation of the chronological sequence of the individual cuts being made. The web of corrugated board 2 is cut into three continuous sectional webs of corrugated board B₁, B₂ and B₃ by two separating cuts T₁ and T₂. The first separating cut T₁ comprises a first longitudinal separating cut L₁₁ in a position x₁₁ as related to a margin 13, a second longitudinal separating cut L₁₂ in a position x₁₂ and a connecting crosscut Q₁ which is perpendicular to the separating longitudinal separating cuts L₁₁ and L₁₂, connecting them. The first longitudinal separating cut L₁₁ and the second longitudinal separating cut L₁₂ overlap in the conveying direction 3. The length of the connecting crosscut Q₁ is such that the length exceeds x₁₂−x₁₁ and the connecting crosscut Q₁ laps over the first longitudinal separating cut L₁₁ as well as the second longitudinal separating cut L₁₂ crosswise of the conveying direction 3.

The structure of the separating cut T₂ corresponds to the separating cut T₁, comprising a first longitudinal separating cut L₂₁ in a position x₂₁, a second longitudinal separating cut L₂₂ in a position x₂₂ and a connecting crosscut Q₂ which is perpendicular to the longitudinal separating cuts L₂₁ and L₂₂, connecting them. The first and second longitudinal separating cuts L₂₁ and L₂₂ overlap in the conveying direction 3. The length of the connecting crosscut Q₂ is selected such that the length exceeds x₂₁−x₂₂ and the connecting crosscut Q₂ laps over the first and second longitudinal separating cuts L₂₁ and L₂₂ crosswise of the conveying direction 3. The first longitudinal separating cuts L₁₁ and L₂₁ end at a position y₁₁ and y₂₁ in the conveying direction 3, with y₁₁=y₂₁. The second longitudinal separating cuts L₁₂ and L₂₂ start at the position y₁₂ and y₂₂ in the conveying direction 3, with y₁₂ being equal to y₂₂. The connecting crosscuts Q₁ and Q₂ are disposed in a position y₁ and y₂ in the conveying direction 3, with y₁=y₂. An area of format change 29 of a width Δy is defined in the vicinity of the connecting crosscuts Q₁ and Q₂. The width of the area of format change 29 must be at least Δyₘᵢₙ=Y₁₂−y₁₁.

The sectional webs of corrugated board B₁ to B₃ are additionally provided with numerous longitudinal cuts Sₖ. They are only shown in FIG. 4 and not in the other figures. The various sectional webs B₁, B₂, B₃ are allocated to various formats of sheets of corrugated board. The longitudinal separating cuts Sₖ serve for dividing a sectional web of corrugated board Bᵢ into individual longitudinal strips which, after crosscuts have been made by the cross cutter 6, are cut into sheets of corrugated board 9. The longitudinal cuts Sₖ are made such that the sectional webs of corrugated board Bᵢ are still continuous even in the case of a change of format. As a rule, this is accomplished by the longitudinal cuts Sₖ extending from outside only as far as to the area of format change 29. It is also possible that some longitudinal cuts Sₖ extend as far as into the area of format change 29, it being ensured that the sectional webs of corrugated board Bᵢ stay continuous. Moreover, the web of corrugated board 2, in the vicinity of its margins 13, comprises marginal cuts Rₘ, which are however not relevant to the invention and, therefore, only roughly outlined in FIG. 4. The marginal strips 30, which are produced by the marginal cuts Rₘ, are continuous. Producing the longitudinal cuts Sₖ takes place in the longitudinal-cutter units 11a and 11b. For the production of the marginal cuts Rₘ, provision is made for a margin-cutter unit in the cutter and grooving unit 4. However, it is also possible to produce the marginal cuts Rₘ by the longitudinal-cutter units 11a and 11b.

The mode of operation of the corrugating plant 1 is going to be described below. The standard operation will be described first. The continuous web of corrugated board 2 passes in the conveying direction 3 through the corrugating plant 1. In the first longitudinal-cutter unit 11a, the web of corrugated board 2—apart from the longitudinal cuts Sₖ which will not be mentioned anymore below—is being provided with the first longitudinal separating cuts L₁₁ and L₂₁, with the width of the cut sectional webs of corrugated board B₁ to B₃ being set by the positions x₁₁ and x₂₁ of the first longitudinal separating cuts L₁₁ and L₂₁. The knives of the first longitudinal-cutter unit 11a engage with the web of corrugated board 2 for the job of cutting the sectional webs of corrugated board B₁ to B₃. The cut sectional webs of corrugated board B₁ to B₃ pass through the second longitudinal-cutter unit 11b and the cross-cutter unit 12, both of which not having any task at first. In the switch 5, the three sectional webs of corrugated board B₁ to B₃ are being divided into three levels and supplied to the three sectional cross cutters 7 which are located one on top of the other, where the sectional webs of corrugated board B₁ to B₃ are being cut into sheets of corrugated board 9 and transferred via the conveyor belts 8 to a respective depository stack 10.

Upon a change of format, the desired new width of the sectional webs of corrugated board B₁ to B₃ is set first. To this end, the knives of the second longitudinal-cutter unit 11b, which are necessary for the production of the second longitudinal separating cuts L₁₂ and L₂₂, are being moved into the desired positions x₁₂ and x₂₂. The knives of the second longitudinal-cutter unit 11b are now being engaged with the web of corrugated board 2, slightly before the knives of the first longitudinal-cutter unit 11a withdraw from the web of corrugated board 2. This helps produce the overlap of the first and second longitudinal separating cuts. After the knives of the second longitudinal-cutter unit 11b have engaged with the web of corrugated board 2, the knives of the first longitudinal-cutter unit 11a disengage from the web of corrugated board 2. Then the other knives of the second longitudinal-cutter unit 11b move in, producing the longitudinal separating cuts Sₖ. In FIG. 4, this takes place on the margin of the area of format change 29 which is thus defined.

For producing continuous separating cuts T₁ and T₂, the associated connecting crosscuts Q₁ and Q₂ must be made. To this end, the corresponding cutting supports 20 are being moved into the first position i.e., the position of cutting, underneath the roll 15, and the other cutting supports 20 into the second position i.e., the non-cutting position. With the web of corrugated board 2 passing through the cross-cutter unit 12 and the rotation of the roll 15 being controlled correspondingly, the knife 18 will make the connecting crosscuts Q₁ and Q₂. The position of the connecting crosscuts Q₁ and Q₂ crosswise of the conveying direction 3 is determined by the cutting supports 20 which are in the first position. The length of the connecting crosscuts Q₁ and Q₂ is determined by the width of the cutting supports 20 which are in the first position. For wider cuts to be produced, two directly adjacent cutting supports 20 can be disposed in the position of cutting. This will produce a longer connecting crosscut. After application of the connecting crosscuts Q₁ and Q₂, continuous separate sectional webs of corrugated board B₁ to B₃ have been produced, with the width of the sectional webs of corrugated board B₁ and B₃ being greater after the change of format according to FIG. 4 and the width of the sectional web of corrugated board B₂ being smaller.

For dividing the sectional webs of corrugated board B₁ to B₃ after the change of format, it is necessary to adapt the switch elements 27 to the changed widths of the sectional webs of corrugated board B₁ to B₃ so that the sectional webs of corrugated board B₁ to B₃ can be divided reliably into three levels. After adjustment of the position of the switch elements 27, the sectional webs of corrugated board B₁ to B₃ of changed width are being delivered on three levels to the three sectional cross cutters 7 where sheets of corrugated board 9 of another format are cut to size. The area of change of format 29 is being sorted out.

Producing the separating cuts T₁ and T₂ can also take place in a different way. The first longitudinal-cutter unit 11a can for example additionally comprise two side by side water-jet cutting devices which are movable indepently of each other crosswise of the conveying direction 3. They can produce continuous, uninterrupted separating cuts T₁ and T₂. Moreover, it is possible that knives are provided which are pivotable about an axis that is perpendicular to the web of corrugated board 2. In this case, continuous and uninterrupted separating cuts T₁ and T₂ can be produced too. It is also possible that the cross-cutter unit 12 produces connecting crosscuts Q₁ and Q₂ which are not vertical, but extend at an angle to the conveying direction 2.

FIG. 5 illustrates a second exemplary change of format by the corrugating plant 1. The cuts Sₖ and Rₘ are not shown. The essential difference from the first change of format resides in that the positions of the connecting crosscuts Q₁ and Q₂ are not identical in the conveying direction 3 i.e., y₁≠y₂. They are not level. The first longitudinal separating cut L₁₁ of the first separating cut T₁ ends upstream of the first longitudinal separating cut L₂₁ of the second separating cut T₂ i.e., y₁₁≠y₂₁. Consequently, the second longitudinal separating cut L₁₂ of the first separating cut T₁ starts upstream of the second longitudinal separating cut L₂₂ of the second separating cut T₂ i.e., y₁₂≠y₂₂. The respective first and second longitudinal separating cuts overlap in the known manner. Likewise, the connecting crosscuts Q₁ and Q₂ are disposed as known.

At first, the knives of the first longitudinal-cutter unit 11a are in engagement with the web of corrugated board 2. The knife, allotted to the separating cut T₁, of the second longitudinal-cutter unit 11b is being engaged with the web of corrugated board 2 in the position x₁₂ for commencement of the change of format. Then the knife, allotted to the separating cut T₁, of the first longitudinal-cutter unit 11a is being detached from the web of corrugated board 2. Afterwards, the knife, belonging to the separating cut T₂, of the second longitudinal-cutter unit 11b engages with the web of corrugated board 2 in the position x₂₂. Then the second knife, belonging to the second separating cut T₂, of the first longitudinal-cutter unit 11a is being removed from the web of corrugated board 2. The first and second connecting crosscuts Q₁ and Q₂ are being made in the cross-cutter unit 12. For application of the first connecting crosscut Q₁, a correspondingly placed cutting support 20 moves into the first position underneath the roll 15. By correspondingly triggered rotation of the roll 15, the knife 19 produces the connecting crosscut Q₁ in the position y₁. Then this cutting support 20 is being moved into the second position and another cutting support 20 of another crosswise position is being moved into the first position underneath the roll 15. Correspondingly controlled rotation of the roll 15 helps produce the connecting crosscut Q₂ at the position y₂. The width of the sectional web of corrugated board B₁ has increased after the change of format and the width of the sectional web of corrugated board B₃ has decreased. The width of the sectional web of corrugated board B₂ does not change. The width of the area of change of format 29 in case of the change of format of FIG. 5 exceeds that of the change of format of FIG. 4. The advantage of the change of format according to FIG. 5 resides in that the subsequent adjustment of the switch elements 27 may take place successively in the switch 5. The charge of format according to FIG. 5 can also be regarded as two successive changes of format, with only the respective width of two sectional webs of corrugated board B₁ and B₂ or B₂ and B₃, being modified.

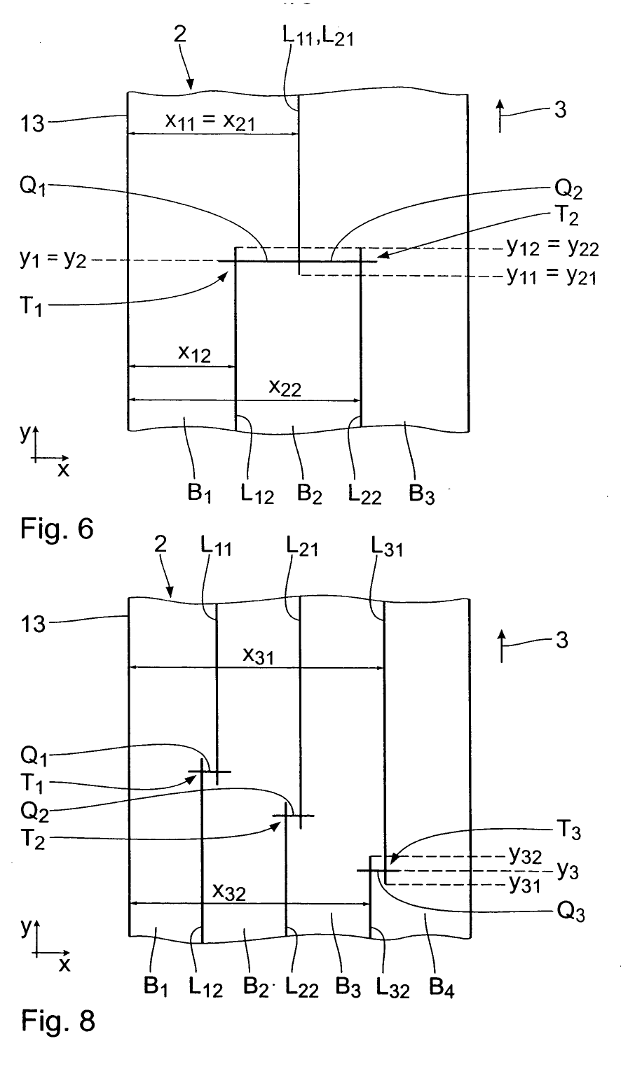

FIG. 6 shows a third exemplary change of format, during which three sectional webs of corrugated board B₁ to B₃ are being produced from initially two sectional webs of corrugated board B₁ and B₃. This change of format can also be considered as a special case of the change of format according to FIG. 4. Prior to the change of format, the separating cuts T₁ and T₂ lie one on top of the other i.e., the positions x₁₁ and x₂₁ of the first longitudinal separating cuts L₁₁ and L₂₂ are identical. After the change of format, the second longitudinal separating cuts L₁₂ and L₂₂ have different positions x₁₂ and x₂₂. Producing the connecting crosscuts Q₁ and Q₂ in the position y₁=y₂ generates the new sectional web of corrugated board B₂. After the change of format, the width of the original sectional webs of corrugated board B₁ and B₃ is reduced because of the production of the new sectional web of corrugated board B₂.

Prior to the change of format, a knife of the first longitudinal-cutter unit 11a engages with the web of corrugated board 2 for producing the first longitudinal separating cut L₁₁ in the position x₁₁=x₂₁. For commencement of the change of format, the knives of the second longitudinal-cutter unit 11b are being engaged with the web of corrugated board 2 in the positions x₁₂ and x₂₂. Then the knife of the first longitudinal-cutter unit 11a is removed in the position x₁₁. For connection of the longitudinal separating cuts L₁₁, L₁₂ and L₂₂, the connecting crosscuts Q₁ and Q₂ are then made in the cross-cutter unit 12 in the position y₁=y₂. To this end, the corresponding cutting supports 20 are being moved into the first position underneath the roll 15. By the rotation of the roll 15 being correspondingly triggered, the connecting crosscuts Q₁ and Q₂ are being produced, forming a joint crosscut.

Then the sectional webs of corrugated board B₁ to B₃ are divided into three levels by the switch 5 and fed to the sectional cross cutters 7 for sheets of corrugated board 9 to be cut to size. Of course, it is also possible that a change of format is accompanied with a change-over from three webs of corrugated board to two webs of corrugated board.

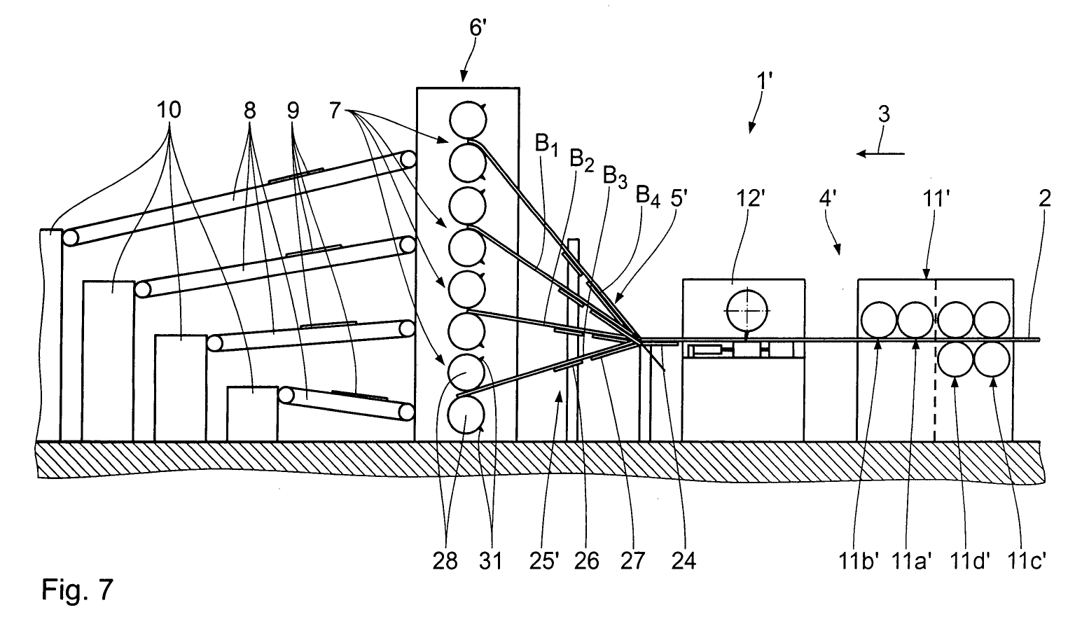

The following is a description of a second embodiment of the invention, taken in conjunction with FIGS. 7 and 8. Constructionally identical parts have the same reference numerals as in the first embodiment, to the description of which reference is made. Functionally identical parts that differ constructionally have the same reference numerals provided with a prime. The essential difference from the first embodiment resides in that the corrugating plant 1′ is designed such that a web of corrugated board 2 can be divided into four sectional webs of corrugated board B₁ to B₄. For the production of three separating cuts T₁ to T₃, the first and second longitudinal-cutter units 11a′ and 11b′ respectively comprise a correspondingly adapted number of knives. In the cross-cutter unit 12′, the number of cutting supports 20 is greater than in the first embodiment. In the switch 5′, the four sectional webs of corrugated board B₁ to B₄ are being divided into four levels on four delivery tables 26 and fed to four sectional cross cutters 7, one on top of the other, of the cross cutter 6′. The sectional cross cutter 7 cut sheets of corrugated board 9 of a different format from the sectional webs of corrugated board B₁ to B₄, the sheets 9 being transported via conveyor belts 8 to four depository stacks 10. A change of format for four sectional webs of corrugated board B₁ to B₄ on the amplified corrugating plant 1′ is seen in FIG. 8. The web of corrugated board 2 comprises three separating cuts T₁ to T₃ for the production of four sectional webs of corrugated board B₁ to B₄. The additional separating cut T₃ comprises a first longitudinal separating cut L₃₁ in the position X₃₁, a second longitudinal separating cut L₃₂ in the position x₃₂ and a connecting crosscut Q₃ in the position y₃, which is perpendicular to the longitudinal separating cuts L₃₁ and L₃₂. The chronological sequence of the change of format and the mode of operation of the corrugating plant 1′ correspond to the first embodiment.

Fundamentally, the cutter and grooving unit 4 can be embodied such that any number of sectional webs of corrugated board Bᵢ can be produced and divided. The sectional webs of corrugated board Bᵢ are separated from each other by associated separating cuts Tⱼ, with j=i−1 applying generally. The separating cuts Tⱼ are formed by first longitudinal separating cuts Lⱼ₁, second longitudinal separating cuts Lⱼ₂ and associated connecting cross cuts Qⱼ. For the production of greatest possible flexibility and productivity in the manufacture of sheets of corrugated board 9, the first and second longitudinal-cutter unit 11a, 11b must embodied such that the width of each sectional web of corrugated board Bᵢ crosswise of the conveying direction 3 can be predetermined and set variably. The cross-cutter unit 12 must therefore be able to produce connecting crosscuts Qⱼ of a predetermined length and predetermined position of the web of corrugated board 2.

What is claimed is:

1. A corrugating plant (1; 1′) for manufacturing sheets of corrugated board (9), comprising
a. a corrugating machine for producing at least one continuous web of corrugated board (2) which is transportable in a conveying direction (3);
b. a cutter (11a, 11b, 12; 11a′, 11b′, 12′) for producing, from the at least one web of corrugated board (2), several continuous sectional webs of corrugated board (Bᵢ) which are allocated to varying formats of sheets of corrugated board (9),
i. it being possible to predetermine and variably adjust the width of each sectional web of corrugated board (Bᵢ, i=1, 2, 3 . . . ) crosswise of the conveying direction (3), and
ii. the sectional webs of corrugated board (Bᵢ) being separated from each other by associated separating cuts (Tⱼ, j=1, 2, 3 . . . );
c. a switch (5; 5′) for dividing sectional webs of corrugated board (Bᵢ) into at least three levels; and
d. a cross cutter (6; 6′) which is disposed downstream of the switch (5; 5′), having at least three sectional cross cutters (7) for cutting to size sheets of corrugated board (9) from each continuous sectional web of corrugated board (Bᵢ).

2. A corrugating plant according to claim 1, wherein the cutter (11a, 11b, 12; 11a′, 11b′, 12′) for producing a separating cut (Tⱼ, j=1, 2, 3 . . . ) at least comprises a first longitudinal-cutter unit (11a; 11a′) for producing a first longitudinal separating cut (Lⱼ₁, j=1, 2, 3 . . . ), a second longitudinal-cutter unit (11b; 11b′) for producing a second longitudinal separating cut (Lⱼ₂, j=1, 2, 3 . . . ) and a cross-cutter unit (12; 12′) for producing a connecting crosscut (Qⱼ, j=1, 2, 3 . . . ) which connects the first longitudinal separating cut (Lⱼ₁, j=1, 2, 3 . . . ) and the second longitudinal separating cut (Lⱼ₂).

3. A corrugating plant according to claim 2, wherein the cross-cutter unit (12; 12′) is disposed downstream of the longitudinal-cutter units (11a, 11b; 11a′, 11b′) in the conveying direction (3).

4. A corrugating plant according to claim 2, wherein the cross-cutter unit (12; 12′) is embodied for the connecting crosscut (Qⱼ), upon a change of format, to be produced with a predetermined length in a predetermined crosswise position.

5. A corrugating plant according to claim 2, wherein the cross-cutter unit (12; 12′) is embodied for the connecting crosscut (Qⱼ), upon a change of format, to be perpendicular to the longitudinal separating cuts (Lⱼ₁, Lⱼ₂).

6. A method of manufacturing sheets of corrugated board (9) on a corrugating plant (1; 1′), comprising the following steps:
a. providing a continuous web of corrugated board (2) which is transported in a conveying direction (3);
b. cutting, from the web of corrugated board (2), several continuous sectional webs of corrugated board (Bᵢ) which are allocated to varying formats of sheets of corrugated board, it being possible to predetermine and variably adjust the width of each sectional web of corrugated board (Bᵢ, i=1, 2, 3 . . . ) crosswise of the conveying direction (3);
c. dividing the sectional webs of corrugated board (Bᵢ) on a switch (5; 5′) into at least three levels; and
d. cutting to size sheets of corrugated board (9) from each continuous sectional web of corrugated board (Bᵢ).

7. A method according to claim 6, wherein the width of at least a part of the sectional webs of corrugated board (Bᵢ) changes during a job of cutting the continuous sectional webs of corrugated board (Bᵢ) upon a change of format.

8. A method according to claim 7, wherein, chronologically prior to the sectional webs of corrugated board (Bᵢ) being divided on the switch (5; 5′), connecting crosscuts (Qⱼ, j=1, 2, 3 . . . ) are produced, which are necessary for the change of format.

9. A method according to claim 8, wherein at least three sectional webs of corrugated board (Bᵢ) are available chronologically prior to, or after, the change of format.

10. A method according to claim 8, wherein two sectional webs of corrugated board (Bᵢ) are available chronologically prior to, or after, the change of format.
